(19) United States
(12) Patent Application Publication
(10) Pub. No.: US 2005/0046193 A1
(43) Pub. Date: Mar. 3, 2005

(54) Starter having pinion-rotation-restricting member

(75) Inventor: Tadahiro Kurasawa, Chita-gun (JP)

Correspondence Address: OLIFF & BERRIDGE, PLC, P.O. BOX 19928, ALEXANDRIA, VA, 22320, US

(73) Assignee: DENSO CORPORATION, Kariya-city (JP)

(21) Appl. No.: 10/889,131

(22) Filed: Jul. 13, 2004

(30) Foreign Application Priority Data
Aug. 29, 2003 (JP) 2003-307388

(51) Int. Cl. H02P 9/04; F02N 11/00

(52) U.S. Cl. 290/38 R

(57) ABSTRACT

A starter for cranking an internal combustion engine includes an electric motor, an output shaft driven by the motor, a pinion gear spline-coupled to the output shaft, a restricting member, and a magnetic switch having a plunger. Movement of the plunger is transmitted to the restricting member via a crank bar connecting the plunger and the restricting member. After the pinion gear is engaged with a ring gear of the engine by restricting its rotation by the restricting member, the engine is cranked up by rotating the pinion gear at a full speed. The crank bar is separated into two parts, and after the two parts are assembled into the starter and correctly positioned therein, two parts are firmly connected to each other. In this manner, a process of assembling is simplified, and the crank bar couples the magnetic switch to the restricting member without forming operating gaps.

### CROSS-REFERENCE TO RELATED APPLICATION

This application is based upon and claims benefit of priority of Japanese Patent Application No. 2003-307388 filed on Aug. 29, 2003, the content of which is incorporated herein by reference.

### BACKGROUND OF THE INVENTION

1. Field of the Invention

The present invention relates to a starter for cranking an internal combustion engine, and more particularly to a starter having a member for restricting rotation of a pinion gear for establishing engagement between the pinion gear and a ring gear of the engine.

2. Description of Related Art

Examples of this type of starter are disclosed in JP-A-9-217672 and JP-A-10-18950. The starter has a pinion unit spline-coupled to an output shaft that is driven by an electric motor and a pinion-rotation-restricting member that engages with the pinion unit to restrict rotation thereof. When the electric motor rotates, the pinion unit is shifted on the output shaft toward a ring gear of the engine while rotation of the pinion unit is restricted. After the engagement between the pinion unit and the ring gear is established, the pinion unit is rotated at a full speed to thereby crank up the engine.

In this starter, a magnetic switch for driving a crank bar that in turn drives the pinion-rotation-restricting member is positioned at an axial end opposite to the other axial end where the pinion unit is positioned. Therefore, it is unavoidable to make the crank bar long so that it extends one axial end to the other axial end of the starter. In addition, since the crank bar has a crank-shape, it is not easy to install the crank bar in the starter in an assembling process. In particular, it is difficult to assemble the starter from its front housing side by stacking components one by one. Accordingly, the process of assembling the starter has been time-consuming and costly.

Further, it has been difficult in the conventional starter to keep a clearance or a gap small between the crank bar and a component to which the crank bar is connected. This is because certain clearances have to be provided in various components to allow the crank-shaped bar to be mounted in the starter. If the gap or clearance between the crank bar and the magnetic switch is large, movement of the magnetic switch is not efficiently transferred to the crank bar. To decrease the gap or clearance, both ends of the crank bar have to be bent precisely. This also increases the manufacturing costs.

### SUMMARY OF THE INVENTION

The present invention has been made in view of the above-mentioned problem, and an object of the present invention is to provide an improved starter which can be easily assembled using a crank bar manufactured at a low cost.

The starter for cranking an internal combustion engine is composed of: an electric motor; an output shaft driven by the electric motor; a pinion unit spline-coupled to the output shaft; a pinion-rotation-restricting member; a magnetic switch for supplying electric current to the electric motor; and a crank bar connecting the magnetic switch to the pinion-rotation-restricting member to bring the pinion-rotation-restricting member into engagement with the pinion unit.

Upon closing a key-switch, the magnetic switch is energized, and rotation of the pinion unit is restricted by the pinion-rotation-restricting member. Then, the electric motor is slowly rotated to bring the pinion unit into engagement with a ring gear of the engine while rotation of the pinion unit is restricted. After the engagement between the pinion unit and the ring gear is established, the motor is rotated at a full speed to there by crank up the engine. After the engine is cranked up, the key-switch is opened to thereby de-energize the magnetic switch and to return the pinion unit to its initial position.

The crank bar connecting the magnetic switch and the pinion-rotation-restricting member is composed of a driving portion coupled to the pinion-rotation-restricting member, a coupling portion coupled to the magnetic switch, and a straight portion connecting the driving portion and the coupling portion. The straight portion and the driving portion are integrally formed (as a first part), and the coupling portion (as a second part) is formed separately from the first part. The first part and the second part are assembled into the starter and correctly positioned therein, and then the coupling portion is firmly connected to the straight portion, so that there exists no contacting gap in the direction in which the crank bar is driven by the magnetic switch.

Since the crank bar is composed of two parts when it is assembled into the starter, a process of assembling the starter components including the crank bar can be easily carried out. After the coupling portion and the driving portion are correctly positioned to make close contact with respective components, the coupling portion is firmly connected to the straight portion by fastening a nut, or the like. Therefore, no contact gaps are made in the operating direction, and movement of the magnetic switch is effectively transmitted to the pinion-rotation-restricting member via the crank bar.

The crank bar may be separated in other ways. That is, it may be separated into two parts, a first part including the coupling portion and the straight portion and a second part consisting of the driving portion. Alternatively, the crank bar may be separated into three portions, the coupling portion, the straight portion and the driving portion. After all of the separated parts or portions are correctly positioned in the starter, they are firmly connected to one another without forming contacting gaps in the direction in which the crank bar is driven by the magnetic switch.

Other objects and features of the present invention will become more readily apparent from a better understanding of the preferred embodiments described below with reference to the following drawings.

### BRIEF DESCRIPTION OF THE DRAWINGS

FIG. 1 is a cross-sectional view showing a starter for cranking an internal combustion engine, as a first embodiment of the present invention;

FIG. 2 is a circuit diagram showing electrical connections in the starter;

FIG. 3 is a plan view showing a swing ring and its vicinity, viewed from a front axial end of the starter;

FIG. 4 is a plan view showing a rear axial end of the starter, a rear cover being partially broken to show a connection between a plunger and a coupling portion of a crank bar;

FIG. 5 is a plan view showing a hook of a plunger, to which the coupling portion of the crank bar is coupled, in an enlarged scale;

FIG. 6 is a plan view showing a way of connecting a coupling portion to a straight portion of the crank bar;

FIG. 7 is a plan view showing another way of connecting the coupling portion to the straight portion of the crank bar;

FIG. 8 is plan view showing yet another way of connecting the coupling portion to the straight portion of the crank bar;

FIG. 9 is a plan view showing the coupling portion and the straight portion of the crank bar connected by staking;

FIG. 10 is a plan view showing a crank bar formed by a first part including a straight portion and a coupling portion and a second part including a driving portion, as a second embodiment of the present invention; and

FIG. 11 is a plan view showing a crank bar formed by three parts, as a third embodiment of the present invention.

### DETAILED DESCRIPTION OF THE PREFERRED EMBODIMENTS

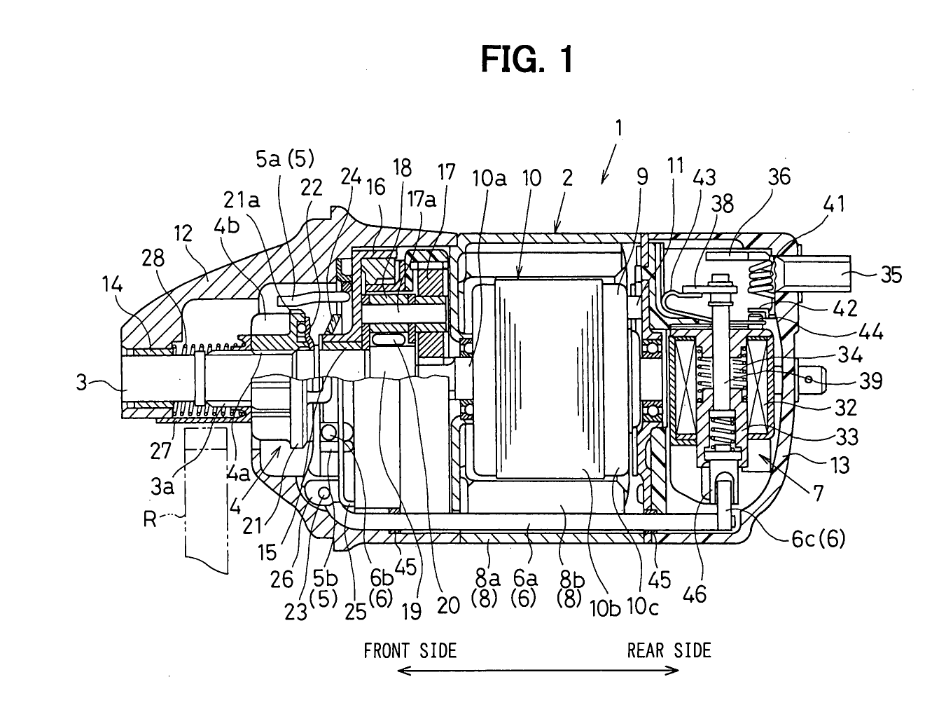

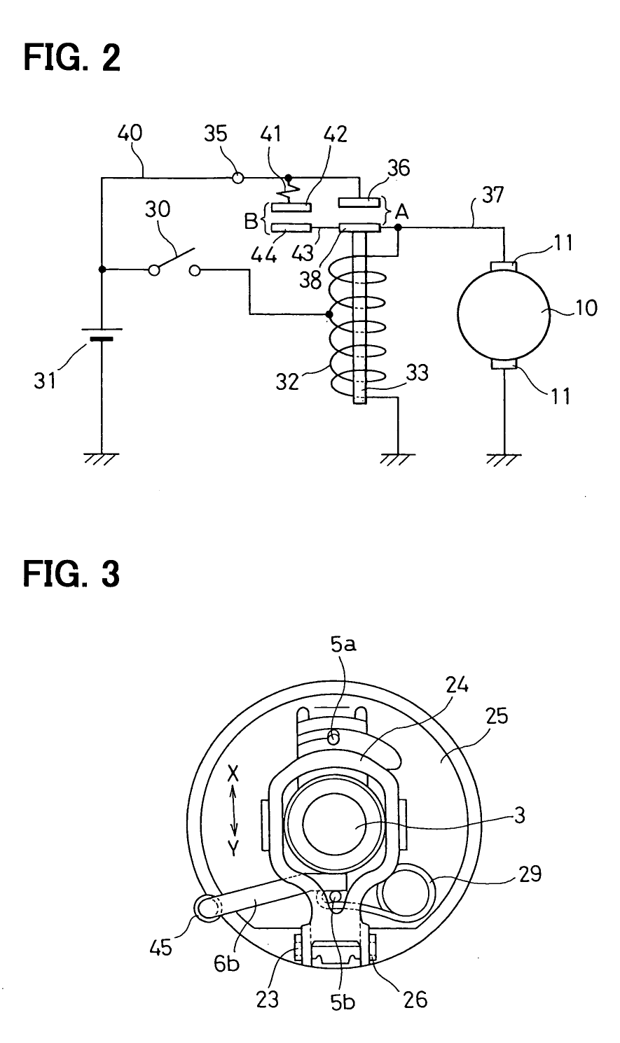

A first embodiment of the present invention will be described with reference to FIGS. 1-9. FIG. 1 shows a starter 1 for cranking an internal combustion engine, to which the present invention is applied. This starter 1 is a so-called pinion-rotation-restricting type starter that is used for cranking a relatively small engine. The starter 1 is composed of: an electric motor 2 generating rotational torque; an output shaft 3 driven by the electric motor 2; a pinion unit 4 slidably coupled to the output shaft 3; a pinion-rotation-restricting member 5 that engages with the pinion unit 4 for restricting its rotation; a magnetic switch 7 that controls electric power supply to the electric motor 2 in an ON-and-OFF fashion and operation of the pinion-rotation-restricting member 5; and other associated components. The magnetic switch 7 includes a main switch A and an auxiliary switch B as shown in FIG. 2, which will be described latter in detail.

The electric motor 2 is a known type of motor that is composed of a stator 8 for supplying a magnetic field and an armature 10 rotatably disposed in the stator 8, the armature 10 having a commutator 9 through which electric current is supplied to the armature 10 via brushes 11. The electric motor 2 is held between a front housing 12 and the end cover 13. The stator 8 is composed of a cylindrical yoke 8a and permanent magnets 8b disposed inside the yoke 8a. The armature 10 includes an armature core 10b around which an armature coil 10c is wound, an armature shaft 10a press-fitted into a center hole of the armature core 10b. Coil ends of the armature coil 10c bent on a rear axial end surface of the armature core 10b are utilized as the commutator 9. Brushes 11 slidably contact on the surface of the commutator 9 in the axial direction of the armature 10.

The output shaft 3 is coaxially disposed with the armature shaft 10a at the front side of the starter 1 and is rotatably supported by a bearing 14 held in the front housing 12 and another bearing 15 held in a center case 16 that is disposed inside the front housing 12. A known type of a planetary gear speed reduction mechanism and a one-way clutch are interposed between the armature shaft 10a and the output shaft 3.

The planetary gear speed reduction mechanism is composed of a sun gear formed at the front end of the armature shaft 10a and planetary gears 17 engaging with the sun gear. Each planetary gear 17 rotates around a gear shaft 17a, and all the planetary gears orbit around the sun gear. The one-way clutch is composed of a clutch outer 18 to which the gear shafts 17a are fixed, a clutch inner 19 formed integrally with the output shaft 3, and clutch rollers 20 disposed between the clutch outer 18 and the clutch inner 19. The clutch outer 18 rotates together with the orbital rotation of the planetary gears 17, and transmits a rotational torque of the armature 10 to the clutch inner 19 via the rollers 20. Thus, the rotation of the armature 10, speed of which is reduced by the planetary gear reduction mechanism, is transmitted to the output shaft 3. Transmission of the rotational torque from the output shaft 3 to the armature 10 is interrupted by the one-way clutch.

The pinion unit 4 is composed of a pinion gear 4b and a flange 21 formed at a rear side of the pinion gear 4b. The flange 21 has a diameter larger than that of the pinion gear 4b, and a series of depressions 21a are formed on the outer periphery of the flange 21. A female spline 4a is formed in the inner bore of the pinion unit 4, and a male spline 3a is formed on the outer periphery of the output shaft 3. Both splines 3a and 4a are coupled to each other, and thereby the pinion unit 4 is spline-coupled to the output shaft 3 so that the pinion unit 4 slidably moves on the output shaft 3 in the axial direction while the output shaft 3 rotates and rotation of the pinion unit 4 is restricted. The pinion unit 4 is biased toward the rear side by a pinion spring 28 disposed between the front end of the front housing 12 and the pinion unit 4.

A thrust washer 22 are positioned at the rear side of the pinion unit 4 so that the thrust washer 22 freely rotates relative to the pinion unit 4. As shown in FIG. 3, a swing ring 24 that swings around a support pin 23 held by supports 26 according to an axial movement of the pinion unit 4 is positioned at the rear side of the thrust washer 22. The swing ring 24 is formed in a ring shape surrounding the output shaft 3, and both sides thereof is held by a pair of claws (not shown) formed on the thrust washer 22. A plate 25 is positioned between the swing ring 24 and the center case 16, and the supports 26 supporting the support pin 23 are formed on the plate 25. A shutter 27 for closing or opening a front opening of the front housing 12 is disposed at the front side of the pinion unit 4 and is pushed toward the front axial end of the pinion unit 4 by a pinion spring 28.

The pinion-rotation-restricting member 5 is made of a metallic bar wound in a coil shape that includes a first end 5b and a second end 5a, both being bent at right angle toward the front side of the starter 1. The pinion-rotation-restricting member 5 is disposed in a space between the plate 25 and the center case 16 and biased by a return spring 29 in X-direction shown in FIG. 3. The pinion-rotation restricting member 5 is movable in X-Y direction and is driven downward, i.e., in Y-direction by a driving portion 6b of a crank bar 6 in a manner described later in detail. The second end 6a of the pinion-rotation-restricting member 5 engages with the depression 21a formed on the flange 21 when the pinion-rotation-restricting member 5 is driven downward. The first end 6b is connected to the diving portion 6b of the crank bar 6, as shown in FIG. 3.

The structure of the magnetic switch 7 will be described with reference to FIGS. 1 and 2. The magnetic switch 7 is composed of a coil 32 to which electric current is supplied from a battery 31, a plunger 33 disposed inside the coil 32 and driven by the magnetic force generated in the coil 32, a return spring 34 that biases the plunger 33 downward, a main switch A, an auxiliary switch B, both switches being adapted to be operated by the plunger 33, and other associated components. The magnetic switch 7 is disposed at the rear side of the electric motor 2 so that the plunger 33 is positioned perpendicularly to the axial direction of the armature 10 and is contained in the rear cover 13.

As shown in FIG. 2, the main switch “A” is composed of a main stationary contact 36 connected to the battery 31 via a battery cable 40 and a main movable contact 38 connected to the brush (plus side) 11 via a brush lead wire 37. As shown in FIG. 1, the main movable contact 38 is held by a plunger rod 39 (the main movable contact 38 is insulated from the plunger rod 39) that is connected to the plunger 33. The main movable contact 38 facing the main stationary contact 36 is driven by the plunger 33. The terminal bolt 35 is fixed to the end cover 13 and extends to the rear side of the starter 1, and the battery cable 40 is connected to the terminal bolt 35.

The auxiliary switch “B” is connected in parallel to the main switch “A” as shown in FIG. 2. The auxiliary switch B is composed of an auxiliary stationary contact 42 electrically connected to the main stationary contact 36 via a resistor 41 and an auxiliary movable contact 44 electrically connected to the main movable contact 38 via a resilient metal plate (e.g., a copper plate) 43. The auxiliary movable contact 44 facing the auxiliary stationary contact 42 is driven by the plunger 33 together with the main movable contact 38. The resistor 41 is formed, for example, by winding a nickel wire in a coil shape. The resistor 41 limits an amount of current flowing through the auxiliary switch B so that the amount of current flowing through the auxiliary switch B becomes lower than an amount of current flowing through the main switch A. As shown in FIG. 1, a distance between the auxiliary stationary contact 42 and the auxiliary movable contact 44 is made smaller than a distance between the main stationary contact 36 and the main movable contact 38. Therefore, the auxiliary switch B closes before the main switch A closes.

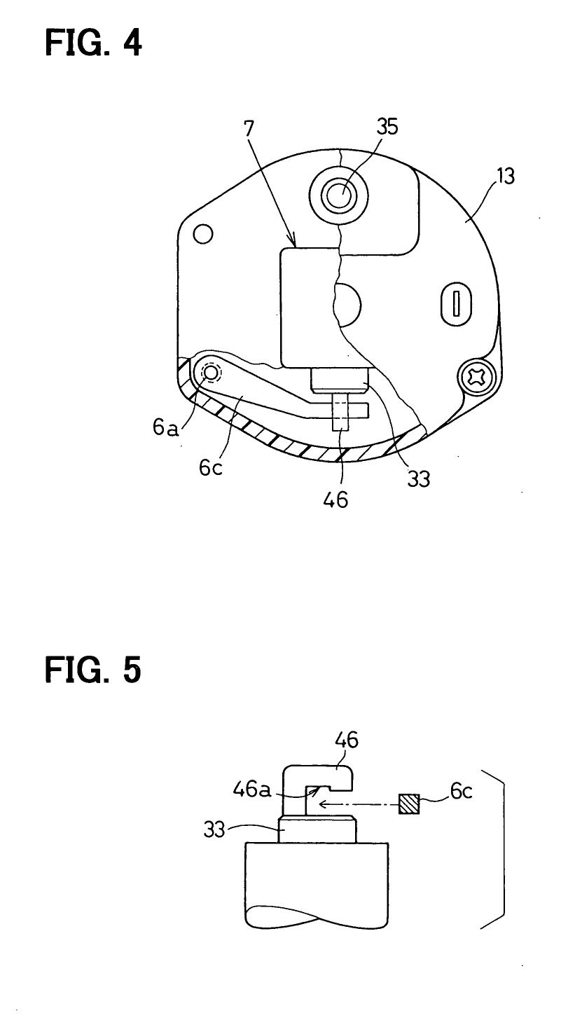

As shown in FIG. 1, the crank bar 6 is composed of a first part that includes a straight portion 6a and a driving portion 6b, and a second part having a coupling portion 6c. The straight portion 6a and the driving portion 6b are integrally formed, and the driving portion 6b is bent at right angle from the straight portion 6a. The coupling portion 6c constituting the second part is formed separately from the first part and connected to the first part. The straight portion 6a extends through a space between the permanent magnets 8b connected to the inner bore of the cylindrical yoke 8a and rotatably supported by a pair of bearings 45. The driving portion 6b is positioned so that its end abuts the first end 5b of the pinion-rotation-restricting member 5, as shown in FIG. 3. As shown in FIGS. 4 and 5, one end of the coupling portion 6c engages with a hook 46 of the plunger 33.

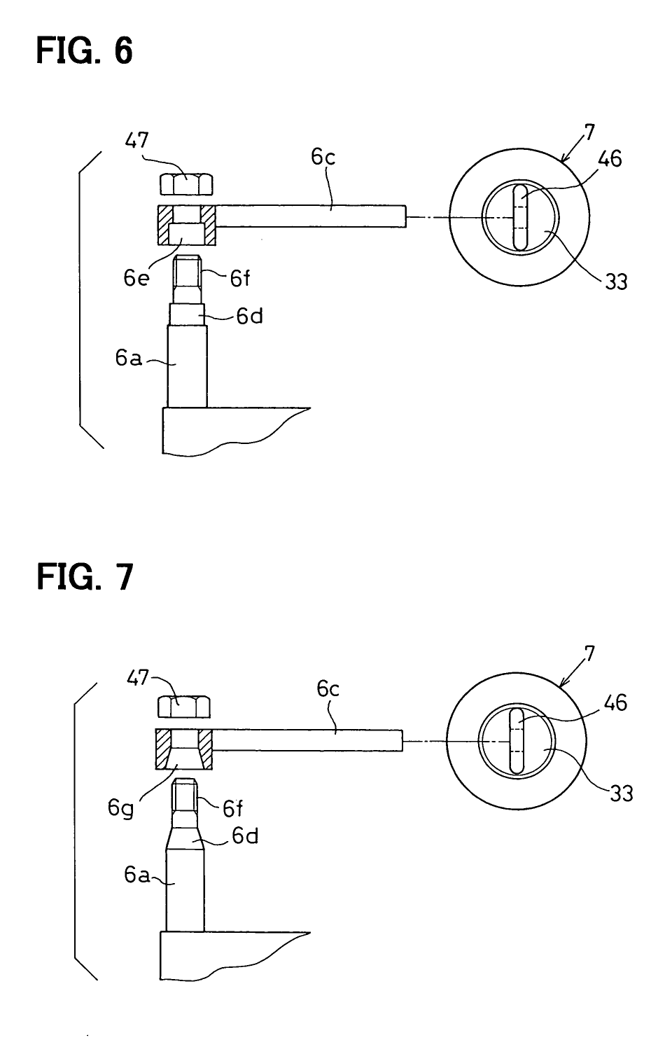

As shown in FIG. 6, the coupling portion 6c is fixedly connected to the straight portion 6a, making right angle therebetween. A stepped portion 6d having a male thread 6f is formed at one end of the straight portion 6a, and a stepped hole 6e is formed at one end of the coupling portion 6c. The stepped portion 6d is inserted into the stepped hole 6e, and then both are fixedly connected by fastening a nut 47 to the male thread 6f.

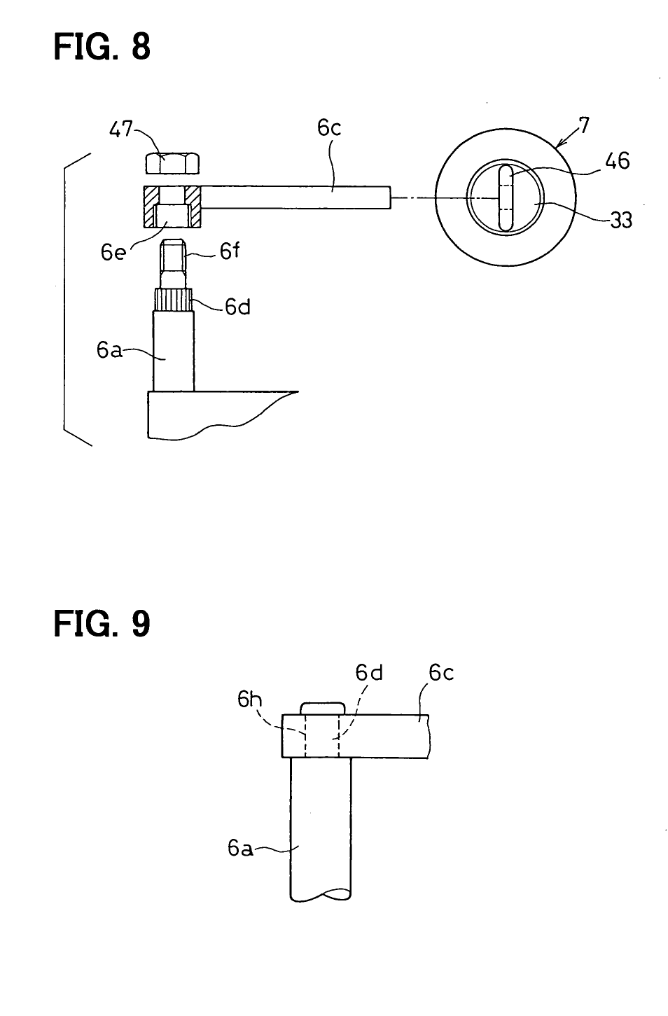

The straight portion 6a and the coupling portion 6c can be connected in various manners other than that shown in FIG. 6. In a connecting manner shown in FIG. 7, a tapered portion 6d having a male thread 6f is formed at one end of the straight portion 6a, and a tapered hole 6g is formed at one end of the coupling portion 6c. The tapered portion 6d is inserted into the tapered hole 6g, and then both are fixedly connected by fastening a nut 47 to the male thread 6f. In a manner shown in FIG. 8, a knurled portion 6d having a male thread 6f is formed at the end of the straight portion 6a, and a stepped hole 6e having an inner bore that is smaller than the outer diameter of the knurled portion 6d is formed at the end of the coupling portion 6c. The knurled portion 6d is forcibly inserted into the stepped hole 6e, and then both are fixedly connected by fastening a nut 47 to a male thread 6f. In a manner shown in FIG. 9, a coupling end 6d formed at the end of the straight portion 6a is forcibly inserted into a round hole 6h formed at the end of the coupling portion 6c, and then the tip portion of the coupling end 6d is staked.

The coupling portion 6c tends to be bent or distorted when it is pulled by the plunger 33. To prevent such bending or distortion, a cross-sectional shape of the coupling portion 6c is made in a shape that is difficult to be distorted in the direction pulled by the plunger 33. For example, the cross-sectional shape is made in a rectangular shape having long sides located in the direction of the pulling force. The end of the coupling portion 6c contacts a contacting surface 46a formed in the hook 46, as shown in FIG. 5, and a certain abrasion occurs therebetween. To alleviate abrasion wear of the coupling portion 6c, the coupling portion 6c is heat-treated, e.g., carbonitrided. The first part including the straight portion 6a and the driving portion 6b, and the coupling portion 6c constituting the second part are made of respectively different material. For example, the first part may be made of S35C and the second part may be made of SPCC.

The crank bar 6 is assembled to the starter 1, so that gaps do not exist in the driving direction between the driving portion 6b and the first end 5b of the pinion-rotation-restricting member 5 and between the coupling portion 6c and the hook 46 of the plunger 33. This is because the driving force of the plunger 33 is not effectively transferred to the pinion-rotation-restricting member 5 through the crank bar 6 if there are gaps at contacting portions. To eliminate the contacting gaps, the crank bar 6 is assembled to the starter 1 in the following manner. First, the straight portion 6a is held by the pair of bearings 45. Then, the driving portion 6b is positioned to abut the first end 5b of the pinion-rotation-restricting member 5 which is pushed upward by the return spring 29 to the position shown in FIG. 3. Then, the coupling portion 6c is positioned to abut the contacting surface 46a of the hook 46. Then, the coupling portion 6c is firmly connected to the straight portion 6a, while keeping the position of driving portion 6b relative to the first end 5b and the position of the coupling portion 6c relative to the contacting surface 46a. In this manner, the crank bar 6 is correctly positioned in the starter 1 without forming the contacting gaps in the direction in which the crank bar 6 is driven by the plunger 33.

Operation of the starter 1 described above will be explained below. Upon closing the key-switch 30, electric current is supplied to the coil 32 of the magnetic switch 7. The plunger 33 disposed inside the coil 32 is moved upward (in FIG. 1) by the magnetic force generated in the coil 32. The movement of the plunger 33 is transmitted to the pinion-rotation-restricting member 5 via the crank bar 6, and the pinion-rotation-restricting member 5 moves in Y-direction shown in FIG. 3. The second end 5a of the pinion-rotation-restricting member 5 engages with the depressions 21a formed on the flange 21 of the pinion unit 4. Thus, rotation of the pinion unit 4 is restricted.

On the other hand, the auxiliary switch B is closed according to the movement of the plunger 33. Electric current, an amount of which is limited by the resistor 41, is supplied to the armature 10. The armature 10 slowly rotates the output shaft 3, while rotation of the pinion unit 4 is restricted. The pinion unit 4 helical-coupled to the output shaft 3 is pushed forward on the output shaft 3 toward the ring gear R of the engine. Thus, the pinion gear 4b engages with the ring gear R.

When the engagement between the pinion gear 4b and the ring gear R is established, the second end 5a of the pinion-rotation-restricting member 5 is disengaged with the depression 21a and is positioned behind the swing ring 24, releasing the pinion unit 4 from restriction. At the same time, the pinion unit 4 is prevented from moving backward (toward the rear side of the starter 1) by the swing ring 24. Then, the main switch A is closed, thereby supplying a full current to the armature 10. The pinion gear 4b is rotated by the armature 10 at a high speed, while being engaged with the ring gear R. Thus, the engine is cranked up.

After the engine is cranked up, the key-switch 30 is opened, and the current supply to the coil 32 is terminated. The magnetic force in the coil 32 disappears, and the plunger 33 is returned to its initial position (the position shown in FIG. 1) by the biasing force of the return spring 34. According to the movement of the plunger 33, the main switch A and the auxiliary switch B are opened. At the same time, the driving portion 6b of the crank bar 6 releases the force pushing down (in Y-direction in FIG. 3) the first end 5b of the pinion-rotation-restricting member 5. The second end 5a moves up (in X-direction) and comes out of the backside of the swing ring 24. The pinion unit 4 is returned to its initial position shown in FIG.1 by the biasing force of the pinion spring 28. Thus, a series of a cranking operation is completed.

Advantages attained in the first embodiment are as follows. Since the crank bar 6 is separated into two parts, the first part and the second part, the crank bar 6 is easily assembled to the starter 1, avoiding interference with other components. This makes it possible to assemble the starter 1 from one side. For example, the front housing 12 may be placed at the bottom most position, and all the components may be stacked one by one from the front side of the starter 1. In this manner, the assembling process can be speeded up.

The driving portion 6b of the crank bar 6 is positioned to closely contact the first end 5b of the pinion-rotation-restricting member 5, and the coupling portion 6c of the crank bar 6 is positioned so that it closely contacts the contacting surface 46a of the plunger 33. While maintaining those close contacts, the straight portion 6a and the coupling portion 6c is firmly connected to each other. In other words, the first part including the straight portion 6a and the driving portion 6b and the second part consisting of the coupling portion 6c are firmly connected to each other, while eliminating the contacting gaps in the direction in which the crank bar 6 is driven. Therefore, the movement of the plunger 33 is effectively transmitted to the pinion-rotation-restricting member 5 via the crank bar 6.

Since the crank bar 6 is separated into the first part and the second part, two parts can be made of respectively different materials suitable to the respective functions. For example, the first part may be made of S35C and the second part may be made of SPCC. The cross-sectional shape of both parts can be made in respectively different shapes. For example, the second part constituting the coupling portion 6c may be formed in a rectangular cross-section so that the coupling portion 6c is not easily distorted by the pulling force of the plunger 33. The first part including the straight portion 6a may be formed in a round cross-section so that the straight portion 6a is not easily twisted by a rotational force.

Since one end of the coupling portion 6c slidably engages with the hook 46, the coupling portion 6c has to be strong against abrasion. Accordingly, the coupling portion 6c is hardened by heat-treatment such as carbonitriding. Further, the first part and the second part of the crank bar 6 are connected to each other after they are assembled or coupled to other components. Therefore, dimensional fluctuations of the components contacting the crank bar 6 can be absorbed in the process of connecting the first part and the second part. This means that a high level of precision in component dimensions and assembling is not required, and therefore the manufacturing costs of the starter can be made lower.

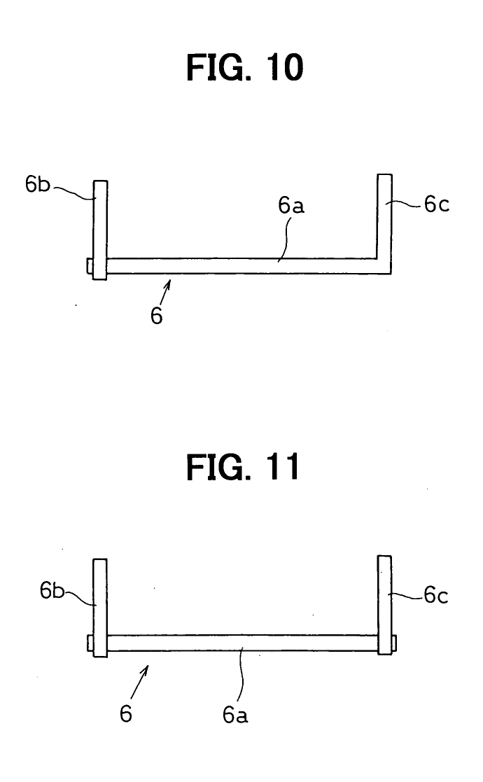

A second embodiment of the present invention will be described with reference to FIG. 10. In this embodiment, the first part of the crank bar 6 is composed of the driving portion 6b, and the second part is composed of the straight portion 6a and the coupling portion 6c. Both parts are connected to each other in the similar manner as in the first embodiment after both parts are assembled to the starter 1. The same advantages as those of the first embodiment are attained in this second embodiment, too. In the process of assembling the second embodiment, the end cover 13 may be positioned at the bottom and other components may be stacked up one by one. The second part that includes the coupling portion 6c requiring abrasion durability may be hardened.

A third embodiment of the present invention will be described with reference to FIG. 11. In this embodiment, the crank bar 6 is separated into three portions, i.e., the straight portion 6a, the driving portion 6b and the coupling portion 6c. After three portions are installed or assembled to the starter 1, they are firmly connected to one another in the similar manner as in the first embodiment. The similar advantages attained in the foregoing embodiments can be attained in this third embodiment, too. In addition, no process of bending the bar is required in this embodiment because the crank bar 6 is composed of three straight bars.

While the present invention has been shown and described with reference to the foregoing preferred embodiments, it will be apparent to those skilled in the art that changes in form and detail may be made therein without departing from the scope of the invention as defined in the appended claims.

1. A starter for cranking an internal combustion engine having a ring gear, the starter comprising:
an electric motor;
an output shaft driven by the electric motor;
a pinion unit coupled to the output shaft by means of a helical spline;
a pinion-rotation-restricting member adapted to engage with the pinion unit to restrict rotation of the pinion unit;
a crank bar for bringing the pinion-rotation-restricting member into engagement with the pinion unit;
a magnetic switch having a plunger for driving a switch supplying electric current to the electric motor and for driving the crank bar, wherein:
the pinion unit is slidably sifted on the output shaft toward the ring gear while rotation of the pinion unit is restricted to thereby establish engagement between the pinion unit and the ring gear; and
the crank bar is composed of a coupling portion coupled to the plunger, a driving portion for driving the pinion-rotation-restricting member and a straight portion connected between the coupling portion and the driving portion, at least one of the coupling portion and the driving portion being formed separately from the straight portion and firmly connected to the straight portion after all the portions are assembled into the starter, so that contacting gaps, in a direction in which the crank bar is driven by the plunger, between the coupling portion and the plunger and between the driving portion and the pinion-rotation-restricting member become less than a predetermined distance.

2. A starter as in claim 1, wherein:
the crank bar is composed of a first part including the straight portion and the driving portion, both the straight portion and the driving portions being integrally formed, and a second part including the coupling portion; and
the second part is firmly connected to the first part after both the first part and the second part are assembled into the starter.

3. A starter as in claim 1, wherein:
the crank bar is composed of a first part including the straight portion and the coupling portion, both the straight portion and the coupling portions being integrally formed, and a second part including the driving portion; and
the second part is firmly connected to the first part after both the first part and the second part are assembled into the starter.

4. The starter as in claim 1 or 2, wherein:
the first part and the second part are firmly connected to each other by fastening means.

5. The starter as in claim 4, wherein:
the fastening means is a thread formed on the first part and a nut fastened to the thread.

6. The starter as in claim 2 or 3, wherein:
the first part and the second part are connected to each other by knurl-coupling.

7. The starter as in claim 2 or 3, wherein:
the first part and the second part are connected to each other by taper-coupling.

8. The starter as in claim 2 or 3, wherein:
the first part and the second part are made of respectively different materials.

9. The starter as in claim 2 or 3, wherein:
at least either the first part or the second part is hardened by heat-treatment.

10. The starter as in claim 2 or 3, wherein:
the first part and the second part have respectively different cross-sectional shapes.

11. The starter as in claim 1, wherein:
all of the straight portion, the driving portion and the coupling portion are formed separately from each other; and
those portions are firmly connected one another after those portions are assembled into the starter.
